(19) United States
(12) Patent Application Publication
(10) Pub. No.: US 2015/0262166 A1
(43) Pub. Date: Sep. 17, 2015

(54) Real-Time Portable Device Update

(71) Applicants: Shantnu Singh, Singapore (SG); Taurai Tarugarira, Johannesburg (ZA)

(72) Inventors: Shantnu Singh, Singapore (SG); Taurai Tarugarira, Johannesburg (ZA)

(21) Appl. No.: 14/645,231

(22) Filed: Mar. 11, 2015

Related U.S. Application Data
(60) Provisional application No. 61/951,428, filed on Mar. 11, 2014.

(51) Int. Cl. G06Q 20/34; G06Q 20/40

(52) U.S. Cl. CPC G06Q 20/342; G06Q 20/40

(57) ABSTRACT

Embodiments are directed to systems and methods related to updating a balance on a portable device through a load transaction process. In some embodiments, a transaction request message with a load indicator contained on a transaction amount data field may be sent from an access device to an issuer. The requested load amount may be contained in another data field. The load indicator in the transaction amount data field may prompt the issuer to recognize the transaction request message as a load transaction message. Thus, clearing and settlement processes need not be performed between the acquirer and the issuer. Upon confirming that a payment account identified in the transaction request message has sufficient funds, the issuer generates a transaction response message approving the load transaction. The transaction response message may include a script for updating the balance on the portable device.

### CROSS-REFERENCES TO RELATED APPLICATIONS

This application claims benefit under 35 USC §119(e) to U.S. Provisional Patent Application No. 61/951,428 filed Mar. 11, 2014, the disclosure of which is incorporated by reference herein in its entirety for all purposes.

### BACKGROUND

The use of payment devices, such as credit cards and prepaid cards, has made it increasingly easy for consumers to perform transactions without the use of cash or other similar physical forms of tender. These payment devices have applications both for commercial transactions (e.g., the purchase of goods/services) or access transactions (e.g., transit cards for access to a transportation system or other venue).

Some payment devices, such as prepaid cards, are associated with a limited amount of funds that can be used toward completing financial transactions. Unlike credit cards, prepaid cards do not provide the user with a line of credit. A prepaid card is associated with an account that has a balance. Typically, the balance for prepaid payment devices lies on a host (e.g., the issuer computer for the issuer of the prepaid payment devices). When the prepaid payment device is used in a transaction, a terminal interacting with the prepaid payment device sends a transaction authorization request to check the balance of the account on the host, debits the balance on the host, and completes the transaction. When the balance on the account associated with the prepaid card is lower than a predetermined amount, the user may wish to add value to the balance, i.e. top up the prepaid payment device.

The user may provide tender (e.g. cash, check, credit card) and the prepaid card to an access device, which may relay the request to a payment processor through an acquirer. The payment processor may identify an issuer associated with the prepaid card. The issuer may update the balance on a prepaid account associated with the prepaid card. At a later time, the payment processor may coordinate the clearing and settlement between the issuer and the acquirer.

FIG. 1 illustrates a conventional system that may be used to update the balance associated with a prepaid card. Since the user provides tender (e.g. cash, check, credit card) to the access device (i.e. money is given to a first entity) and the balance associated with the prepaid device is updated by the issuer of the prepaid device (i.e. update is handle by a second entity), the process is a financial transaction. Thus, the balance update is handled in two phases: phase I to update the balance of an account associated with the prepaid device, and phase II to complete clearing and settlement operations between the acquirer and the issuer.

During Phase I 100 illustrated in FIG. 1, the user that is conducting a transaction with a merchant may provide tender 102 and a prepaid card 104 to an access device 106 operated by the merchant at step 1. The access device 106 may generate a transaction authorization request message and send the transaction authorization request message to an acquirer 108 at step 2. The acquirer 108 may be a bank associated with the access device 106. The transaction authorization request message may indicate a request to add a predetermined amount (as identified by the tender 102) to a payment account associated with the prepaid card 104. The acquirer 108 may route the transaction authorization request message to a payment processor 110 at step 3. The payment processor 110 may identify an issuer associated with the prepaid card 104 at step 4 and send the transaction authorization request message to the issuer 112 at step 5. The issuer 112 may maintain a payment account 114 associated with the prepaid card 104. Upon receiving the transaction authorization request, the issuer 112 may increment the balance on the payment account 114 by the amount of the tender 102. The issuer 112 then sends a transaction authorization response message to the payment processor 110 at step 6, which then routes the message to the acquirer 108 at step 7. The acquirer 108 forwards the transaction authorization message to the access device 106 at step 8. At step 9, the access device 106 may generate an output (e.g. a screen display or a paper receipt) informing the user whether the prepaid card has been successfully topped up.

The Phase II 150 illustrated in FIG. 1 is directed to clearing and settlement between the acquirer 108 and the issuer 112. The merchant operating the access device 106 may make the funds (received from the user in form of the tender) available to the acquirer 108 at step 10. At steps 11 and 12, the payment processor 110 settles the amounts owed between the issuer 112 and the acquirer 108. Prior to settlement, clearing messages (not illustrated) may also pass between the acquirer 108, issuer 112, and the payment processor 110 to facilitate the settlement process. Accordingly, the funds originating from the user are transferred to the merchant operating the access device 106, the acquirer 108 and eventually to the issuer 112.

One problem with the typical method described above is that all transactions involving the prepaid payment device are be on-line transactions, in that the access device generates and send a transaction authorization request message to the issuer and wait for a transaction authorization response message. This can be unwieldy and costly in environments with high volumes such as a transit system where there may be hundreds or thousands of patrons passing through the access gate. Cards with offline transaction capability are much more convenient and quicker in these environments.

Moreover, as discussed above in connection with FIG. 1, when the available balance of the prepaid payment device is depleted, the user has to go to a terminal and conduct a financial transaction to add funds to the prepaid payment device. For example, in one current solution, the user interacts with an access device using a payment device and then deposits funds (e.g., cash), the value of which is then loaded on the user's payment device. While this may allow the user to add funds to their payment device, it also requires the user to have cash on hand that can be deposited to the payment device. It also requires that the transaction be handled as a financial transaction. This is because funds are deposited by the user with the merchant, and these funds eventually need to be transferred to the issuer of the payment device through a settlement process.

Another problem is that this method of reloading is often only enabled over proprietary networks.

Embodiments of the invention address these and other problems, individually and collectively.

### SUMMARY

Embodiments of the invention are directed to systems and methods related to updating a balance on a portable device (e.g., a prepaid card) using a load transaction process. In some embodiments, this may be achieved by using a transaction request message, e.g. a load transaction message or an Original Credit Transaction (OCT) message. The transaction request message may include a load indicator (e.g. zero amount “$0”) in the transaction amount data field and a requested load amount in another data field that is different than the transaction amount data field. In a normal credit or debit card transaction, the transaction amount data field contains the amount of the transaction currently being conducted. However, in embodiments of the invention, the load amount is not in the transaction amount data field. In embodiments of the invention, the load indicator in the transaction amount data field may prompt the issuer to recognize the transaction request message as a load transaction message. The load indicator may indicate to the participants in the transaction system (e.g., the acquirer, payment processor, and/or the issuer), that a clearing and settlement processes need not be performed between the acquirer and the issuer.

In some embodiments, a consumer (e.g. user) may present a portable device to a terminal. The terminal may generate a transaction request message including a load amount in a first data field, a zero amount “$0” in a second data field (e.g. the transaction amount data field) and an account number associated with a portable device in a third data field (e.g. account identifier data field). The terminal may send the transaction request message to an acquirer, which may then forward the message to a payment processor. The payment processor may identify an issuer associated with the account number. The payment processor may then send the transaction request message to the issuer. Upon receiving the transaction request message with “$0” in the transaction amount data field, the issuer may recognize the transaction message as a load transaction request message that does not require clearing and settlement processes to be performed when then transaction is complete. The zero amount “$0” is used for illustrative purposes and any amount or flag (e.g. alphanumeric characters, symbols or a combination thereof) may be used to categorize the transaction request message as a load transaction request message.

The issuer may confirm that funds available in a payment account (e.g. a user account) identified by the account number are equal to or more than the load amount. The issuer may generate and send a transaction response message to the payment processor. The transaction response message may indicate that funds are available and that the transaction is approved. The transaction response message may include a script that would allow the terminal or the portable device to top up the balance stored on a memory chip of the portable device. The payment processor may send the load transaction response message to an acquirer, which may then relay the message to the terminal. Upon receiving the load transaction response message approving the transaction, the terminal or a processor of the portable device may update the balance stored on the memory chip of the portable device by the load amount.

Embodiments of the present invention do not transfer funds equal to the load amount from the acquirer to the issuer as in conventional systems, and a conventional clearing and settlement process is not required when updating the balance on the portable device. The user may, however, pay a fee to the merchant for providing the service, and a portion of this fee may be transferred to the acquirer, payment processor, and/or the issuer in a separate process according to some embodiments of the invention.

One embodiment of the invention is directed to a method comprising, receiving, by a server computer, a transaction request message for a transaction after a portable device comprising a data processor and a memory unit interacts with the access device. The transaction request message includes a plurality of data fields comprising a transaction amount data field, a supplemental data field, and an account identifier data field. The account identifier data field contains an account identifier associated with the portable device, the supplemental data field contains a load amount, and the transaction amount data field contains a load indicator. The method further comprises evaluating, by the server computer, the transaction request message. The method also comprises determining, by the server computer, an authorization computer associated with the account identifier based on the evaluation. In addition, the method comprises sending, by the server computer, the transaction request message to the authorization computer. The method also comprises receiving, by the server computer, a transaction response message indicating approval of the transaction from the authorization computer. The transaction response message includes a script for updating a balance amount in the memory unit in the portable device. The method further includes sending, by the server computer, the transaction response message to the access device. The balance amount stored in the memory unit of the portable device is modified using the script.

Another embodiment of the invention is directed to a server computer comprising a processor for executing instructions to receive a transaction request message for a transaction after a portable device comprising a data processor and a memory unit interacts with the access device. The transaction request message includes a plurality of data fields comprising a transaction amount data field, a supplemental data field, and an account identifier data field. The account identifier data field contains an account identifier associated with the portable device, the supplemental data field contains a load amount, and the transaction amount data field contains a load indicator. The processor further executes instructions to evaluate the transaction request message. The processor also executes instructions to determine an authorization computer associated with the account identifier based on the evaluation. In addition, the processor executes instructions to send the transaction request message to the authorization computer. The processor also executes instructions to receive a transaction response message indicating approval of the transaction from the authorization computer. The transaction response message includes a script for updating a balance amount in the memory unit in the portable device. The processor further executes instructions to send the transaction response message to the access device. The balance amount stored in the memory unit of the portable device is modified using the script.

Another embodiment of the invention is directed to a method comprising interacting, by an access device, with a portable device comprising a data processor and a memory unit. The method also comprises receiving, by the access device, data associated with the portable device, the data including a load amount and an account identifier associated with the portable device. The method further comprises generating, by the access device, a transaction request message including a plurality of data fields comprising a transaction amount data field, a supplemental data field, and an account identifier data field. The account identifier data field contains the account identifier associated with the portable device, the supplemental data field contains the load amount, and the transaction amount data field contains a load indicator. The method also includes sending, by the access device, the transaction request message to an authorization computer through one or more server computers. In addition, the method includes receiving, by the access device, a transaction response message indicating approval of the transaction from the authorization computer. The transaction response message includes a script for updating a balance amount in the memory unit in the portable device. The method further includes modifying, by the access device, the balance amount stored in the memory unit of the portable device using the script.

These and other embodiments of the invention are described in further detail below.

### BRIEF DESCRIPTION OF THE DRAWINGS

FIG. 1 shows a block diagram of a conventional system and a flowchart of a method for updating an available balance associated with a prepaid device.

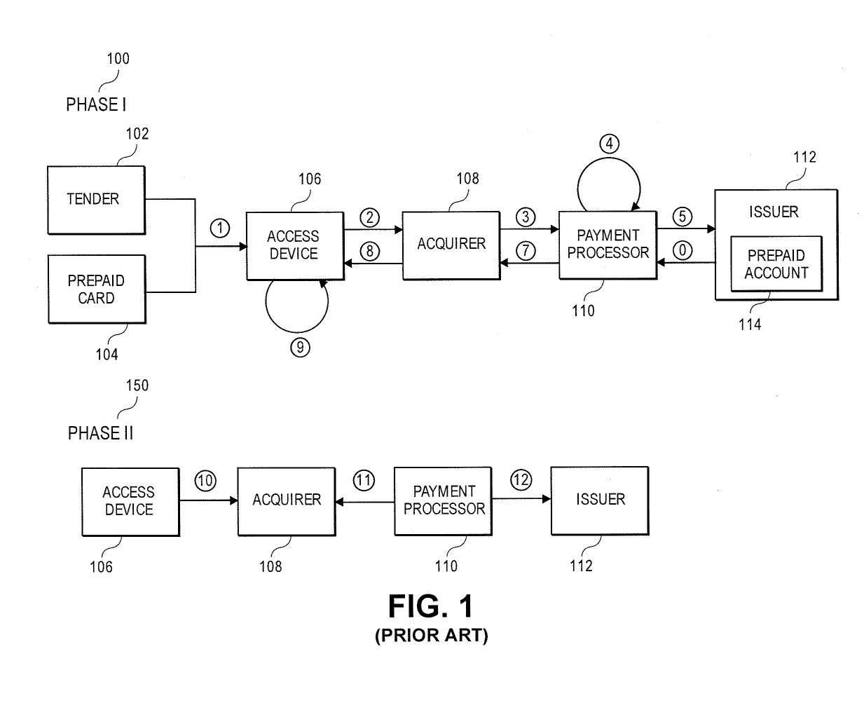

FIG. 2 shows a block diagram of a system and a flowchart of a method for updating an available balance on a portable device according to an embodiment of the invention.

FIG. 3 shows an exemplary portable device in the form of payment card according to an embodiment of the invention.

FIG. 4 shows an exemplary flowchart of steps performed by a payment processing network server computer for updating an available balance on a portable device according to an embodiment of the invention.

FIG. 5 shows an exemplary flowchart of steps performed by an access device for updating an available balance on a portable device according to an embodiment of the invention.

FIG. 6 shows a conventional transaction request message for conducting a financial transaction.

FIG. 7 shows an exemplary transaction request message for conducting a load transaction to update an available balance on a portable device according to an embodiment of the invention.

FIG. 8 shows an exemplary block diagram of a computer system.

### DETAILED DESCRIPTION

Embodiments of the present invention are directed to enhancing the process of updating a balance on a portable device. Embodiments of the invention are more efficient and less resource-consuming than conventional computer implemented systems and processes. Embodiments of the present invention may use modified transaction request/response messages including load indicators that categorize the top up or balance updating transactions as load transactions that do not require clearing and settlement processes to be performed.

In some embodiments, a balance on a portable device (e.g., a prepaid card) may be updated using a load transaction process. This may be achieved by using a transaction request message, e.g. an Original Credit Transaction (OCT) message, to send the requested load amount from an access device to an issuer. The transaction message may have multiple data fields. The transaction request message may include zero amount “$0” in a transaction amount data field and the load amount in another data field. The zero amount in the transaction amount data field may prompt the issuer to recognize the transaction request message as a load transaction message. In other embodiments, there may no amount in the transaction amount data field (i.e. the transaction amount data field may be blank). Thus, clearing and settlement processes need not be performed between the acquirer and the issuer in embodiments of the invention.

According to various embodiments, the transaction request message may also include an account identifier data field that contains an account identifier associated with the portable device. When the issuer receives the transaction request message, the issuer confirms whether there are enough funds in an account identified by the account identifier to cover the load amount. That is, the issuer ensures that the balance on the account identified by the account identifier is equal to or greater than the requested load amount.

Upon verifying that the account has sufficient funds, the issuer generates a transaction response message approving the transaction. The transaction response message may include a script that, when received by the access device, causes the access device to modify the balance on the portable device by the requested load amount. In some embodiments, a processor of the portable device may use the script to update the balance stored on a memory chip of the portable device.

Before discussing specific embodiments and examples, some descriptions of terms used herein are provided below.

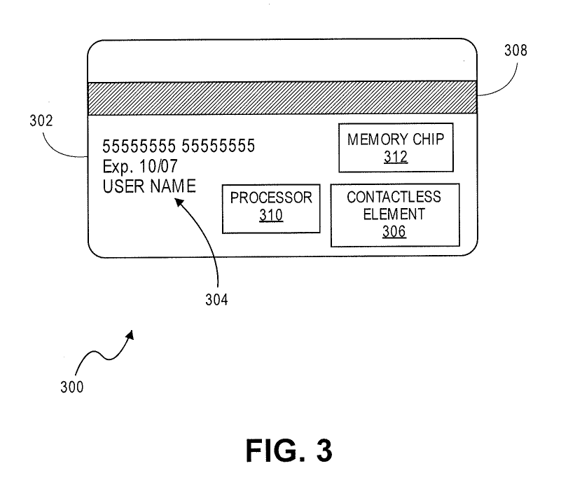

A “portable device” may refer to any device that may be used to conduct a financial transaction, such as to provide payment information to a merchant. A portable device may be in any suitable form. For example, suitable portable devices may be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of portable devices include cellular phones, personal digital assistants (PDAs), pagers, payment cards, security cards, access cards, smart media, transponders, 2-D barcodes, an electronic or digital wallet, wearable devices such as smart watches, fitness bands, ankle bracelets, rings, earrings, and the like. If the portable device is in the form of a debit, credit, or smartcard, the payment device may also optionally have features such as magnetic stripes. Such devices can operate in either a contact or contactless mode. An exemplary portable device is described below in connection with FIG. 3. In some embodiments, the portable device may include a mobile device.

A “mobile device” may comprise any electronic device that may be transported and operated by a user, which may also provide remote communication capabilities to a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. A mobile device may comprise any suitable hardware and software for performing such functions, and may also include multiple devices or components (e.g. when a device has remote access to a network by tethering to another device—i.e. using the other device as a modem—both devices taken together may be considered a single mobile device). A mobile device may also comprise secured hardware or software component within the mobile device and/or one or more external components that may be coupled to the mobile device.

An “access device” may be any suitable device for accessing a remote computer. In some embodiments of the invention, an access device may communicate with a merchant computer or a payment processing network, and may interact with a portable device, a user computer apparatus, and/or a user mobile device. An access device may generally be located in any suitable location, such as at the location of a merchant. An access device may be in any suitable form. Some examples of access devices include point of sale (POS) devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like. An access device may use any suitable contact or contactless mode of operation to send or receive data from, or associated with, a portable device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a portable device.

An “authorization computer” may be a computer that is programmed to determine whether or not transactions can be authorized. An authorization computer may be programmed to perform various checks including fraud checks, account balance checks, etc.

An “issuer” may typically refer to a business entity (e.g., a bank) that maintains financial accounts for a user and often issues a credit or debit card to the user. An issuer can include a payment account issuer. The issuer may be responsible to make a credit limit available to account holders and may also be responsible for sending payments to merchants for purchases made with payment accounts issued by the issuer. The issuer may authorize a requested load amount to be uploaded to a payment device. The issuer may operate an “authorization computer” to perform the foregoing actions.

A “payment account” or a “financial account” (which may be associated with one or more portable devices) may include any suitable payment account including a credit card account, a checking account, a savings account, a merchant account assigned to a accountholder, or a prepaid account.

A “server computer” or a “server” can be a powerful computer or a cluster of computers. For example, the server computer can be a large mainframe, a minicomputer cluster, or a group of servers functioning as a unit. In one example, the server computer may be a database server coupled to a Web server.

A “payment processor” may refer to an electronic payment system used to accept, transmit, or process transactions made by payment devices for money, goods, or services. The payment processor may transfer information and funds among issuers, acquirers, merchants, and payment device users.

A “transaction request message” may be an electronic message that is transmitted to an authorization computer and requests authorization for a transaction. In some embodiments, a transaction request message is sent to a payment processing network and/or an issuer (i.e., an issuer computer) of a payment account to request authorization for a payment transaction. A transaction request message according to some embodiments may comply with ISO 8583, which is a standard for systems that exchange electronic transaction information associated with a payment made by a consumer using a payment device or a payment account.

A transaction request message may comprise multiple data fields, such as an “account identifier data field”, a “transaction amount data field” and a “supplemental data field”. The account identifier data field may contain data identifying an account, including but not limited to, for example, a service code, a CVV or CVC (card verification value or code), a dCVV or dCVC (dynamic card verification value or code), token cryptogram, an expiration date, an account number, etc.

In a conventional systems and methods, a transaction request message contains a transaction amount that is associated with a purchase amount of a purchase of goods or services from a merchant.

In embodiments of the invention, however, the transaction amount data field may contain a load indicator, such as a flag or a predetermined amount (e.g. $0, $1 or [symbol] 0). When the load indicator is received by the authorization computer of the issuer, the load indicator identifies the transaction message as a load transaction message that does not require a clearing and settlement process between the issuer and the acquirer.

A “supplemental data field” may be a data field that contains supplemental data. It may be in addition to data fields that are in a conventional authorization request message or it may be part of a data field in a conventional authorization request message. For example, a supplemental data field may include field 55, a discretionary data field, or some other data field that can carry supplemental data. he supplemental data field may include any value other than the predetermined amount contained in the transaction amount data field. The supplemental data field may include a load amount that the consumer wishes to load to their portable device.

A “load amount” may refer to an amount that the consumer wishes to load to their portable device. For example, the portable device may be a payment device. The load amount may represent any amount that the user wishes to have available on the payment device. The load amount may also be referred as a top up amount. In some embodiments, the load amount may be any amount other than the value included in the transaction amount data field of the transaction request message. In this way, the value in the transaction amount data field may be used as a unique identifier that is used to classify the transaction request message as a load transaction request message. According to various embodiments, the load amount may be debited to an account held at the issuer and may be credited to the portable device issued by the issuer. Accordingly, the load amount does not transfer between two entities but rather is moved between an account held at the issuer and a portable device (e.g. a payment card issued by the issuer, a software application developed on behalf of the issuer, etc.).

A “transaction response message” may be an electronic message reply to a transaction request message. It may be generated by an issuing financial institution (i.e. using an issuer computer) or a payment processing network. The transaction response message may include an authorization code, which may be a code that an account issuing bank returns in response to an authorization request message in an electronic message (either directly or through the payment processing network) to the merchant's access device (e.g. POS terminal) that indicates approval of the transaction. The code may serve as proof of authorization. In some embodiments, the transaction response message may include a script that, when received at the acquirer device, may cause/enable the acquirer device to load a required load amount on to the portable device. In other embodiments, the transaction response message may include a script that can be used by a processor of the portable device to load a required load amount on to memory chip of the portable device.

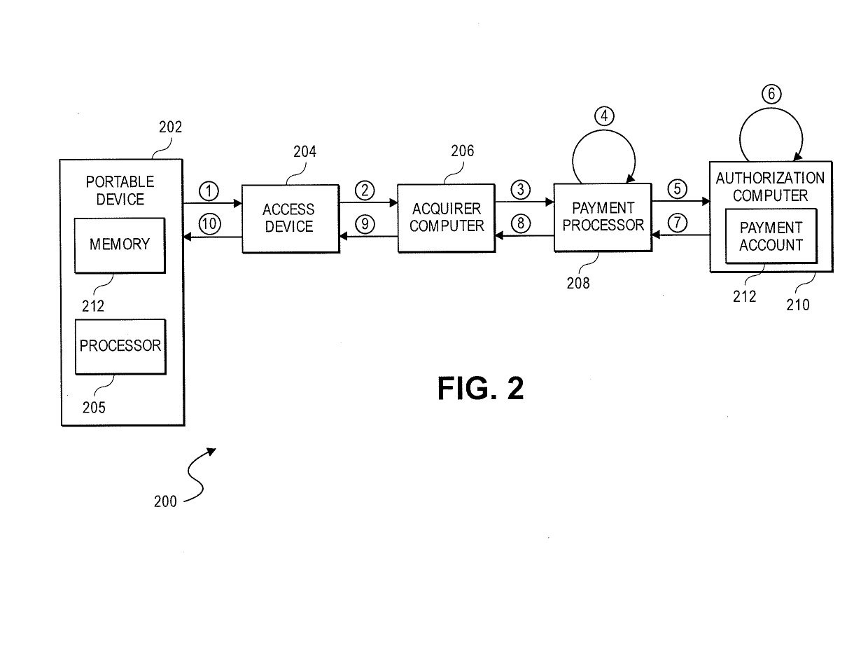

Embodiments of the present invention may be used in transaction processing systems or may use data generated during transaction processing through a transaction processing system. Such embodiments may involve transactions between consumers and merchants. FIG. 2 shows a block diagram of a system 200 for topping up the available balance of funds on a portable device according to various embodiments. The system 200 includes a portable device 202 (e.g. a payment device), an access device 204, an acquirer computer 206, a payment processor 208, and an authorization computer 210 (e.g. issuer computer). For simplicity of illustration, a certain number of components are shown in FIG. 2. It is understood, however, that embodiments of the invention may include more than one of each component. In addition, some embodiments of the invention may include fewer than or greater than all of the components shown in FIG. 2. In addition, the components in FIG. 2 may communicate via any suitable communication medium (including the internet or other communication networks), using any suitable communications protocol.

The portable device 202 may be in any suitable form. For example, suitable portable devices 202 can be hand-held and compact so that they can fit into a consumer's wallet and/or pocket (e.g., pocket-sized). The portable device 202 can include a processor 205, and a memory chip 203, input devices, and output devices, operatively coupled to the processor 205. The portable device 202 may be associated with a user (e.g., consumer). The portable device 202 may be issued by an issuer and associated with a payment account 212 with the issuer. The user may be any individual or business using the portable device 202 to conduct a transaction with a merchant. Specific examples of portable devices 202 include debit devices (e.g., a debit card), credit devices (e.g., a credit card), stored value devices (e.g., a pre-paid or stored value card). The portable device 202 can also be cellular or wireless phones, personal digital assistants (PDAs), pagers, portable computers, smart cards, wearable devices and the like. A portable device 202 in the form of a payment card 300 is depicted in FIG. 3.

As depicted in the exemplary embodiment shown in FIG. 3, the portable device 300 may be in the form of a card. As shown, the portable device 300 comprises a plastic substrate 302. In some embodiments, a magnetic stripe 308 may also be on the plastic substrate 302. In some embodiments, a contact and/or contactless element 306 for interfacing with an access device (e.g., a point of sale device or merchant terminal device) may be present on, or embedded within, the plastic substrate 302. As noted above and shown in FIG. 3, the portable device 300 may include both a magnetic stripe 308 and a contact and/or contactless element 306. In some embodiments, both the magnetic stripe 308 and the contact and/or contactless element 306 may be in the portable device 300. Consumer information 304 such as an account number, card expiration date, and/or a user name may be printed or embossed on the portable device 300. In some embodiments, the portable device 300 may comprise a microprocessor 310 and memory chip(s) 312 with user data stored thereon.

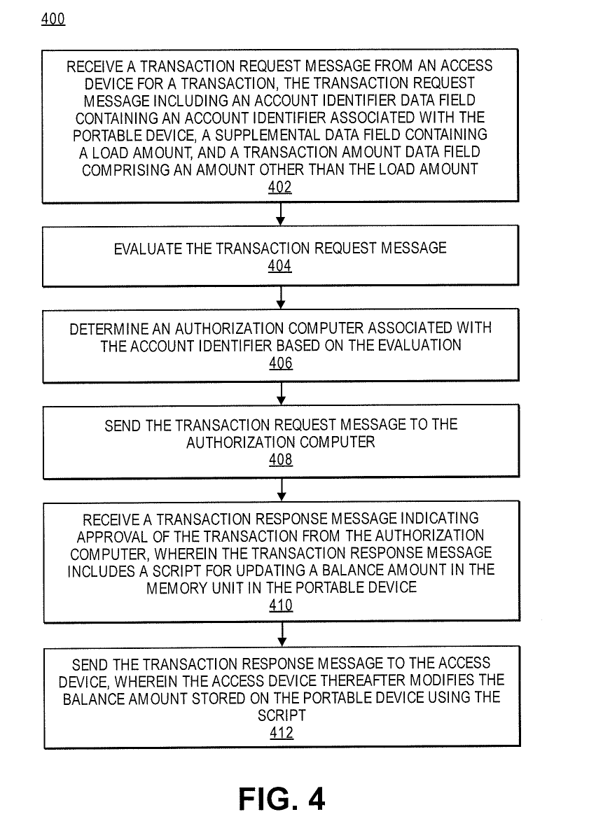

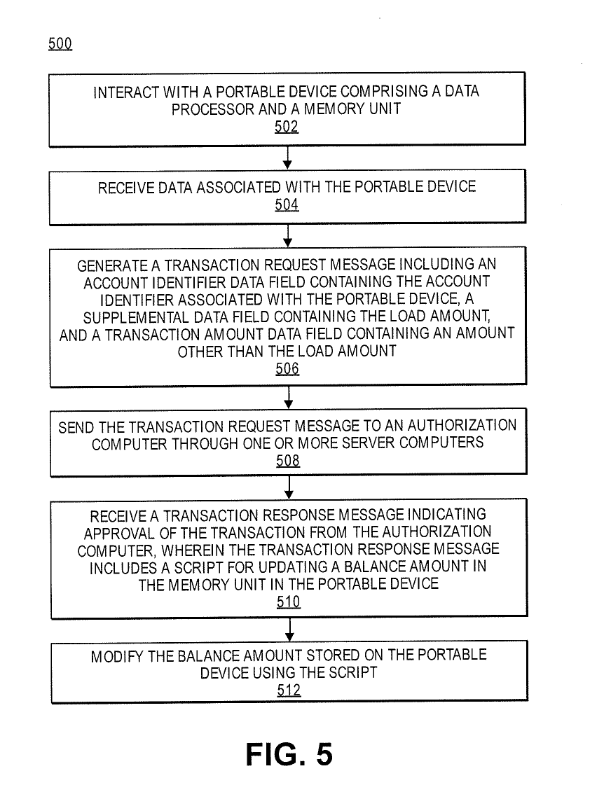

The contact and/or contactless elements 306 or the memory chip 312 may be configured to store data related to the user account including a current available balance on the portable device 300. In such embodiments, the available balance on the portable device 300 may represent some or all of the total account balance on the user account with the issuer. For example, the user account at the issuer may have a balance of $200, while the current available balance on the portable device 300 may be only $100. The current available balance on the portable device 300 may be dependent on the amount of funds that the user has chosen to be placed on the portable device 300. There may be many reasons why the user would want to keep less than the total account balance on the portable device 300, including spending limits/controls or for security by having only some funds directly accessible using the portable device 300 in the case of theft or loss of the portable device 300. Using the embodiments described herein, the user may increase to the available balance on the portable device 300. For example, the user may add a load amount to the available balance on the portable device 300, as discussed below in greater detail in connection with FIGS. 4-5.

Referring back to FIG. 2, in some embodiments, where the portable device 202 is a phone or other similar computing device, the portable device 202 may include a browser stored in a memory and configured to retrieve, present, and send data across a communications network (e.g., the Internet). In such embodiments, the portable device 202 may be configured to send data as part of a transaction. In some embodiments, the portable device 202 may provide the data upon request from another entity, such as the access device 204. In some embodiments, the portable device 202 may be configured to send the data automatically as part of conducting the transaction. If the portable device 202 is a payment card including a contact and/or contactless element 306 as illustrated in FIG. 3, the contact and/or contactless element 306 may be configured to interact with the access device 204.

The access device 204 may be in any suitable form. In some embodiments, the access device 204 can be a device that can interact with the portable device 202 during a purchase transaction or for other types of interactions (e.g., top ups or to obtain account details). Examples of access devices 204 may include, but are not limited to, merchant devices, point of sale (POS) devices, cellular phones, PDAs, personal computers (PCs), tablet PCs, handheld specialized readers, set-top boxes, electronic cash registers, automated teller machines (ATMs), virtual cash registers, kiosks, security systems, access systems, and the like. If the access device 204 is a POS terminal, the access device 204 may include any suitable contact or contactless mode of operation. For example, the access device 204 can include RF (radio frequency) antennas, contact chip readers, magnetic stripe readers, or other means to interact with the portable device 202. In some embodiments, the access device 204 may also be referred to as a merchant computer or other similar computing system.

An acquirer computer 206 is typically a system for an entity (e.g. a bank) that has a business relationship with a particular merchant or other entity. An authorization computer 210 is typically a business entity (e.g. a bank) which maintains financial accounts 212 for the consumer and often issues a portable device 202 such as a credit or debit card to the cardholder. The authorization computer 210 may also be referred as the issuer computer. According to various embodiments, the acquirer computer 206 and the authorization computer may belong to two separate entities (e.g. bank A and bank B). Yet in other embodiments, an entity can perform both authorization computer 210 and acquirer computer 206 functions. Embodiments of the invention encompass both separate entity issuer-acquirers and single entity issuer-acquirers.

The payment processor 208 (also referred as the payment processing network) may include data processing subsystems, networks, and operations used to support and deliver authorization services, exception file services, and clearing and settlement services. For example, the payment processor 208 may comprise a server computer, coupled to a network interface, and a database of information. An exemplary payment processor 208 may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

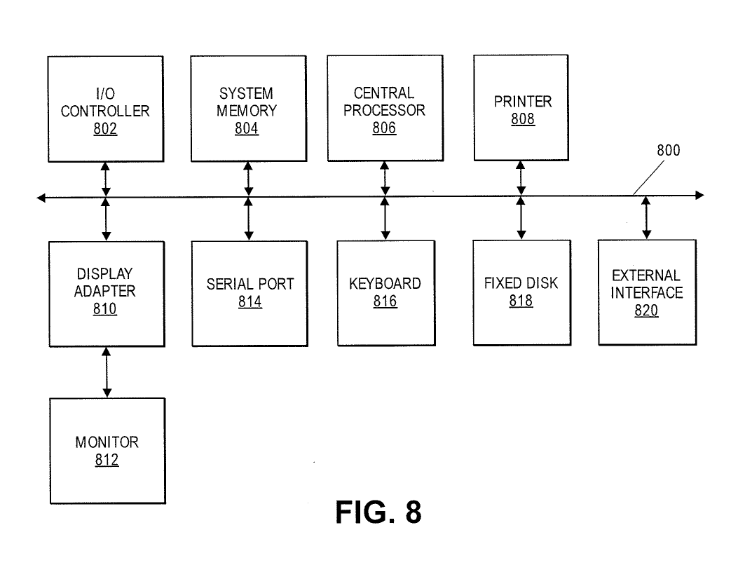

The computing devices (e.g., the portable device 202, access device 204, acquirer computer 206, payment processor 208, and the authorization computer 210) may include a processor and a computer readable medium coupled to the processor, the computer readable medium comprising code, executable by the processor for performing the functionality described herein. An exemplary computing device is illustrated in FIG. 8 and discussed below in greater detail. Each one of the portable device 202, access device 204, acquirer computer 206, payment processor 208, and the authorization computer 210 may include all or a subset of elements illustrated in FIG. 8.

FIG. 2 also illustrates a flowchart of a method for updating an available balance on a portable device according to various embodiments. At step 1, the user may present their portable device 202 at an access device 204 and request a top up amount to be loaded on the portable device 202. In some embodiments, the user may go to an access device (e.g., a merchant terminal or ATM) to perform the load (i.e. explicit collect) process. In some embodiments, the user may insert their portable device 202 through the access device 204 or present their portable device 202 in proximity to the access device 204. The access device 204 may read data from one of either the memory chip 312 or the contactless element 306. The data read from the memory chip 312 or the contactless element 306 may include an account identifier, user data, or any other data that may be used to identify a payment account 212 associated with the portable device 202.

The user may also define an amount of additional funds that the user wishes to be loaded (or topped up) on their portable device 202. For example, the user may currently have $20 as the balance on the portable device 202, and $300 as the full account balance in the payment account 212 with the issuer. The user may indicate that they want the online and/or offline balance on the portable device 202 increased to $100 (e.g., the user is requesting an additional $80 be updated to the balance of the portable device 202). In other embodiments, the amount of top up may be issuer-defined or limited based on user or issuer settings and/or limits. For example, the issuer may limit the amount that can be topped up to the portable device 202 or the user may limit the amount that can be stored on the portable device 202.

At step 2, the data obtained from the portable device 202 and the user is sent to an acquirer computer 206. The access device 204 could send the data obtained from the portable device 202 and the load amount entered into the access device 204 in a data packet to the acquirer computer 206. In some embodiments, the access device 204 at a merchant (or other entity) may generate a transaction request message, and this transaction request message may be transmitted to the acquirer computer 204 with the load amount and the data from the portable device 202. The acquirer computer 206 may be associated with an acquirer, which may have a relationship with the merchant, such as via a financial account.

At step 3, the acquirer computer 206 may receive the transaction request message or may generate the transaction request message if the access device 204 did not do so.

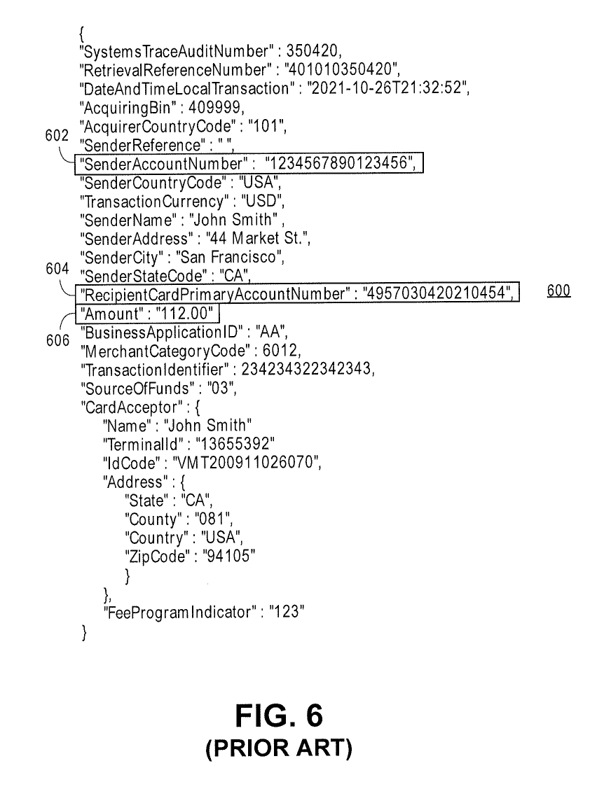

In embodiments of the invention, the transaction request message may include a plurality of data fields. For example, the transaction request message may include an account identifier data field, a transaction amount data field and a supplemental data field. According to various embodiments, the transaction request message may be a modified Original Credit Transaction (“OCT”) message. Typically, an OCT message is used to submit a credit through the payment processor to a recipient's issuer (e.g., in order to fund the recipient's account). The result of the OCT transaction is an instruction to the recipient's issuer to credit the payment card account of the recipient. In the present application, the OCT messages are not used to credit the user account but rather to debit the payment account at the issuer by the load amount, and to load the load amount to the portable device. OCT messages are discussed in greater detail in connection with FIG. 6. Embodiments of the present invention are not limited to using OCT messages, and may utilize modified versions of other types of transaction messages, or a new message type for explicit collect transactions.

The transaction request message may be generated with an identifier (e.g. $0, [symbol] 0, etc.) contained in the transaction amount data field, the account identifying information (e.g. account number) contained in the account identifier data field and the amount of additional funds contained in the supplemental data field (e.g. an explicit collect data field). If the transaction request message is an OCT message, a new field may be defined in the OCT request message, or an existing field in the OCT request message may be used to hold a value indicating the amount of additional funds that the user is requesting to be uploaded to the user's portable device 202.

Based on the example above, the new field may be populated with “80,” which may indicate that the user would like to increase the available balance of the portable device 202 by $80. In embodiments of the present invention, a “$0” in the transaction amount data field may indicate that the transaction request message is for a load transaction (e.g., there is no transfer of funds or settlement of funds between the issuer and the acquirer). The transaction occurs between the authorization computer 210 and the portable device 202. Thus, the funds are transferred from an account managed by the issuer (i.e. the payment account 212) to a device issued and/or authenticated by the issuer (i.e. the portable device 202). The transaction request message may also include a field indicating that the transaction is an explicit collect transaction.

As noted above, in some embodiments of the present invention, the acquirer computer 206 may generate the transaction request message. In other embodiments, the transaction request message may be generated by the access device 204.

The acquirer computer 206 may send the transaction request message to the payment processor 208. At step 4, upon receipt of the transaction request message, the payment processor 208 may analyze the transaction request message and identify the issuer associated with the account identifier included in the account identifier data field of the transaction request message. The payment processor 208 may send the transaction request message to the issuer.

At step 5, the transaction request message is received by the authorization computer 210 at the issuer.

At step 6, the authorization computer 210 may verify the transaction request message and the data contained therein (e.g., the account identifier and the amount of funds requested to be added to the portable device 202). This may also include authenticating the portable device 202 based on the data retrieved from the portable device 202 by the access device 204. Once authenticated, the authorization computer 210 may evaluate a payment account 212 associated with the account identifier and/or the user to determine the current account balance and whether the account 212 has sufficient funds to cover the amount of funds requested to be added (e.g., topped up) to the portable device 202. For a successful load transaction (i.e. explicit collect transaction), the funds in the payment account 212 must be equal to or greater than the amount of funds requested to be added to the portable device 202.

At step 7, when the authorization computer 210 determines that there are sufficient funds in the user's account to cover the top up request, the authorization computer 210 generates a transaction response message indicating that the top up amount is available in the payment account 212. The transaction response message approving the load transaction may also include a script that may enable the access device 204 to top up the balance on the portable device 202. If the authorization computer 210 determines that there are insufficient funds, the transaction response message may indicate that the top up amount is not available in the payment account 212. According to various embodiments, the transaction response message may be an OCT response message.

Continuing the example described above, the balance of the payment account 212 at the authorization computer 210 may be subsequently reduced by $80 to reflect that the $80 has been transferred from the payment account 212 to the balance of the user's portable device 202. The balance may be stored at the memory chip 212 of the portable device 202. According to various embodiments, the balance may be used offline (i.e. for offline transactions such as transit transactions or vending machine transactions).

In alternative embodiments, the payment processor 208 may evaluate the transaction request message, determine whether the top up amount is available in the payment account 212, and generate the transaction response message to be sent back to the access device 204.

At step 8, the transaction response message is sent to the acquirer computer 206 by the authorization computer 210. In some embodiments, the transaction response message is sent to the acquirer computer 206 through the payment processor 208.

At step 9, the access device 204 receives the transaction response message indicating that the top up amount has been verified in the payment account 212. The access device 204 may receive the transaction response message from the acquirer computer 206. The access device 204 may then interact with the portable device 202.

If the transaction response message indicates that the load transaction has been approved by the authorization computer 210, at step 10, the available balance on the portable device 202 is updated. Based on the confirmation contained in the transaction response message, the access device 204 may update the balance on the portable device 202 to include the balance (e.g. load amount) requested by the user in step 1 above. The access device 204 may access the portable device 202 via the memory chip 212 (or the contact and/or contactless element) and update the available balance stored by the portable device 202 using the script included in the transaction response message. In some embodiments, the access device 204 may transfer the script to the portable device 202 so that the processor 205 may modify the balance stored on the memory 212 of the portable device 202.

In some embodiments, the merchant associated with the access device 204 may receive a commission or other fee/value for performing the explicit collect or top up of the balance on the portable device 202. For example, the merchant may receive a percentage of the amount topped up on the portable device 202 or may receive a flat fee regardless of the top up amount. In some embodiments, the amount given to the merchant may be deducted from the top up amount prior to being loaded onto the portable device 202 or may be provided by the user in another form of payment.

After step 10, a clearance and settlement process is not performed by the system shown in FIG. 2.

FIG. 4 illustrates an exemplary flowchart 400 of steps performed by a payment processing network server computer (e.g. payment processor 208) for updating an available balance on a portable device (e.g. portable device 202) according to an embodiment of the invention. After the portable device interacts with an access device, such as a POS terminal at a merchant, the access device or the acquirer computer in communication with the access device generates a transaction request message.

At step 402, the payment processing network server computer receives the transaction request message from the access device, for example, via the acquirer computer. The transaction request message may include an account identifier data field containing an account identifier associated with the portable device. The transaction request message may also include a supplemental data field containing a load amount that the user wishes to upload (i.e. top up or add) to the balance on the portable device. The transaction request message may further include a transaction amount data field comprising an amount other than the load amount. The transaction amount data field may comprise a load indicator. An exemplary load indicator may be a zero currency amount (e.g. $0, [symbol] 0, etc.). The content of the transaction amount data field (i.e. the load indicator) indicates that the message is for a load transaction in the sense that funds are not transferred between two separate issuers, such as two banks.

At step 404, the payment processing network evaluates the transaction request message. For example, the payment processing network may process the account identifier contained in the account identifier data field. Based on the format of the account identifier, the payment processing network may determine an authorization computer (e.g. issuer) associated with the account identifier (step 406). A routing table may be used for this purpose. The payment processing network may then forward the transaction request message to the identified authorization computer (step 408).

Upon receipt, the authorization computer may recognize that the transaction request message is for a load transaction based on the load indicator contained in the transaction amount data field of the transaction request message. For example, if the transaction amount data field contains a zero currency value (e.g. $0), the authorization computer may determine that no funds will be transferred to the acquirer computer or the access device generating the transaction request message. The authorization computer may then analyze subsequent data fields, such as the supplemental data field containing the requested load amount. A value contained in the supplemental data field may indicate to the authorization computer that the transaction request is for a top up (e.g. load) transaction. The authorization computer may determine the payment account identified by the account identifier included in the account identifier data field. If the authorization computer determines that the payment account has enough funds (i.e. funds that are equal to or greater than the requested load amount in the supplemental data field), the authorization computer may generate a transaction response message including a script that will allow the access device to update the balance on the portable device. If the authorization computer determines that the payment account does not have enough funds (i.e. funds that are less than the requested load amount in the supplemental data field), the authorization computer may generate a transaction response message denying the load transaction. In some embodiments, even though the load transaction is denied, the transaction response message may include a data field indicating the available funds on the payment account or a load amount that can be added to the portable device in light of the available funds on the payment account.

At step 410, the payment processor may receive the transaction response message indicating approval of the transaction from the authorization computer. As discussed above, the transaction response message may include the script for updating a balance amount in the memory unit in the portable device.

At step 412, the payment processor sends the transaction response message to the access device. The access device may modify the balance amount stored in a memory unit of the portable device using the script. In some embodiments, the access device itself may use the script to update the balance on the portable device. In other embodiments, the access device may pass the script to the data processor in the portable device to cause the data processor in the portable device to update the balance amount in the memory unit in the portable device.

FIG. 5 shows an exemplary flowchart 500 of steps performed by an access device (e.g. access device 204) for updating an available balance on a portable device (e.g. portable device 202) according to an embodiment of the invention.

At step 502, the access device may interact with a portable device comprising a data processor and a memory unit. For example, the portable device may be swiped through the access device. Alternatively, the portable device may be brought in proximity of the access device.

At step 504, the access device may receive data associated with the portable device. For example, the access device may gather data from the memory unit of the portable device, such as an account identifier associated with the portable device. The access device may also receive input from the user regarding a load amount that the user wishes to upload on the portable device.

At step 506, the access device may generate a transaction request message. The transaction request message may include an account identifier data field containing the account identifier associated with the portable device, a supplemental data field containing the load amount and a transaction amount data field containing an amount other than the load amount. As discussed above, the transaction amount data field may include a load indicator, such as a zero currency amount (e.g. $0, [symbol] 0, etc.). The content of the transaction amount data field (i.e. the load indicator) indicates that the message is for a load transaction in the sense that funds are not transferred between two separate issuers, such as two banks.

At step 508, the access device may send the transaction request message to an authorization computer through one or more server computers, such as an acquirer computer. As discussed above, the authorization computer may analyze the transaction request message and generate a transaction response message.

At step 510, the access device may receive the transaction response message indicating approval of the transaction from the authorization computer. The transaction response message may include a script for updating a balance amount stored in the memory unit of the portable device.

At step 512, the access device may modify the balance amount stored on the portable device using the script included in the transaction response message. In other embodiments, the access device may pass the script to the data processor in the portable device to cause the data processor in the portable device to update the balance amount in the memory unit in the portable device.

According to various embodiments, the transaction request message and the transaction response message may be OCT messages. An OCT (Original Credit Transaction) message is typically used in connection with clearing and settlement processes for money transfer transactions. Using an OCT message, funds are transferred from one entity to another. An OCT message may have a plurality of data fields.

Alternative embodiments of the present invention may be directed to a method comprising receiving a transaction request message from an access device through a payment processor. The transaction request message may include an account identifier data field containing an account identifier associated with the portable device. The transaction request message may also include a supplemental data field containing a load amount. In some embodiments, the load amount may be a balance that the user wishes to upload (i.e. top up or add) to the balance on the portable device. The transaction request message may further include a transaction amount data field comprising a load indicator. In some embodiments, the load indicator may be a zero currency amount (e.g. $0, [symbol] 0, etc.). The method may also include analyzing the data fields of the transaction request message. The method may further include recognizing that the transaction request message is for a load transaction based on the load indicator contained in the transaction amount data field of the transaction request message. The method may also include determining that the transaction request is for a top up (e.g. load) transaction based on the value contained in the supplemental data field. In addition, the method may include identifying a payment account identified by the account identifier included in the account identifier data field and determining whether the payment account has sufficient funds (i.e. funds that are equal to or greater than the requested load amount in the supplemental data field) for the load transaction. The method includes generating a transaction response message including a script for updating the balance on the portable device if it is determined that the payment account has sufficient funds. The method also includes sending the transaction response message to the access device via the payment processor.

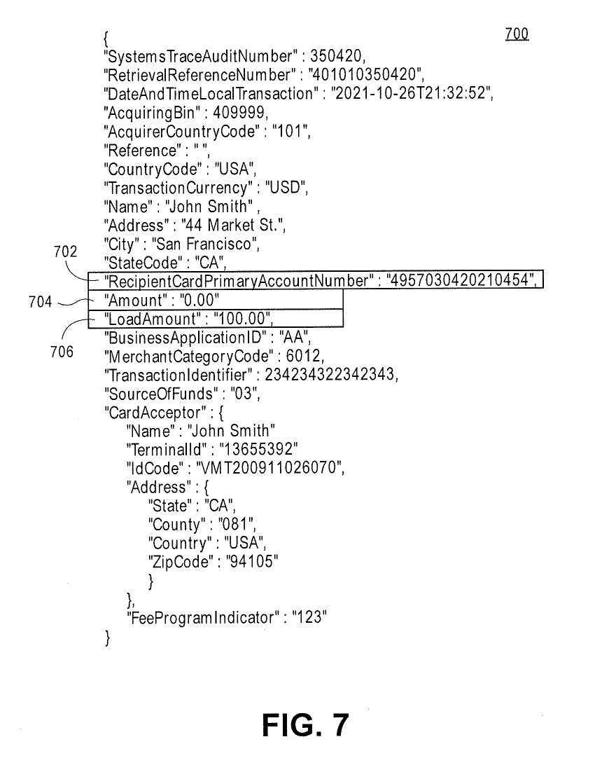

As provided above, according to various embodiments, the transaction request message and the transaction response message may be an OCT message. A conventional OCT message is discussed below in connection with FIG. 6. FIG. 7 illustrates an exemplary OCT message according to various embodiments of the present invention.

FIG. 6 shows a conventional OCT request message 600 for conducting a financial transaction, e.g. sending money from a first entity (i.e. sender) to a second entity (recipient). The exemplary OCT request message 600 includes a first data field 602 containing the sender's account number, a second data field 604 containing the recipient's account number, and a transaction amount data field 606 containing the amount of funds to be debited to the sender and credited to the recipient. During a financial transaction to transfer money from the sender to the recipient, first the funds are secured from the sender. Then, using the OCT request message 600, the funds are credited to the recipient's account number identified in the second data field 604. The clearing and settlement processes between the recipient's issuer and the submitting acquirer device may take a couple of days after the transaction has been approved.

In contrast, embodiments of the present application use the transaction messages, such as OCT messages, for load transactional purposes. Accordingly, no clearing and/or settlement is performed between the issuer and the acquirer computer.

FIG. 7 shows an exemplary OCT request message 700 for conducting a load transaction to update an available balance on a portable device according to an exemplary embodiment of the invention. The exemplary OCT request message 700 may include an account identifier data field 702 containing an account identifier (e.g. an account number) associated with a payment account held at an issuer. The OCT request message 700 may also include a transaction amount data field 706 containing a value (e.g. load amount) that the user wishes to upload on the portable device. In the exemplary embodiment illustrated in FIG. 7, the load amount is “100.00”. The load amount is the amount of funds that will be debited from the account number identified by the account identifier contained in the account identifier data field 702. The exemplary OCT request message 700 may also include a supplemental data field 704 containing a load indicator (e.g. a flag or a predetermined amount) that indicates that the OCT message is for a load transaction, i.e. a load transaction that does not require clearing and settlement processes to be performed. The supplemental data field 704 may be a new field. In some embodiments, the supplemental data field 704 may be an existing field of an OCT request message modified to contain the load indicator. As illustrated in FIG. 7, the load indicator may be a zero value, e.g. “0.00”. Accordingly, when the issuer receives the OCT request message 700, the issuer may recognize that the requested transaction is a load transaction based on the value contained in the supplemental data field 704. The OCT request message 700 may include any additional data fields that may contain additional information relevant for the requested transaction.

In other embodiments of the present invention, other types of pre-existing message formats may be used to perform the explicit collect transaction. For example, other types of messages used to conduct transactions may be used. As with using transaction messages (e.g. OCT messages), other types of messages may be modified by placing the explicit collect-related data in unused fields or by adding a field or load indicator that the message is for a load transaction to perform an explicit collect update to the balance on the portable device.

In additional embodiments of the present invention, instead of modifying the existing transaction messages, the explicit collect transaction to update the balance on the chip on the portable device may be accomplished using a new transaction message type. For example, an explicit collect request message may be defined and configured to carry data required to make the request to update the balance on the chip on the portable device. Similarly, an explicit collect response message may be defined and configured to carry a response from the issuer indicating approval or denial of the explicit collect transaction contained in the explicit collect request message.

Embodiments of the present invention may provide a number of advantages. For example, by modifying the pre-existing transaction messages to include additional fields and data, the explicit collect transaction (e.g., the top up transactions) may be accomplished without any significant changes to infrastructure or systems. The pre-existing transaction messages (e.g. OCT messages) may be modified to carry information indicating that the explicit collect transaction is a load transaction. In other embodiments, other types of pre-existing message formats may be used to perform the explicit collect transaction.

Embodiments of the present invention may provide a benefit of reducing the amount of messaging that are conducted between the various components within the system. For example, the explicit collect transaction is a load transaction that updates the balance of the portable device issued and/or authenticated by the issuer based on the amount in a payment account at the issuer. As such, there is no need to transfer any value between the acquirer computer and the issuer computer (i.e. the authorization computer). The transaction is occurring between the authorization computer of the issuer and the portable device issued and/or authenticated by the issuer.

The various participants and elements described herein may operate one or more computer apparatuses to facilitate the functions described herein. Any of the elements in the above-described FIG. 2, including any servers or databases, may use any suitable number of subsystems to facilitate the functions described herein.

Examples of such subsystems or components are shown in FIG. 8. The subsystems shown in FIG. 8 are interconnected via a system bus 800. Additional subsystems such as a printer 808, keyboard 816, fixed disk 818 (or other memory comprising computer readable media), monitor 812, which is coupled to display adapter 810, and others are shown. Peripherals and input/output (I/O) devices, which couple to I/O controller 802 (which can be a processor or other suitable controller), can be connected to the computer system by any number of means known in the art, such as serial port 814. For example, serial port 814 or external interface 820 can be used to connect the computer apparatus to a wide area network such as the Internet, a mouse input device, or a scanner. The interconnection via system bus allows the central processor 806 to communicate with each subsystem and to control the execution of instructions from system memory 804 or the fixed disk 818, as well as the exchange of information between subsystems. The system memory 804 and/or the fixed disk 818 may embody a computer readable medium.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a server computer, a transaction request message for a transaction after a portable device comprising a data processor and a memory unit interacts with an access device, the transaction request message including a plurality of data fields comprising a transaction amount data field, a supplemental data field, and an account identifier data field, wherein the account identifier data field contains an account identifier associated with the portable device, the supplemental data field contains a load amount, and the transaction amount data field contains a load indicator;
evaluating, by the server computer, the transaction request message;
determining, by the server computer, an authorization computer associated with the account identifier based on the evaluation;
sending, by the server computer, the transaction request message to the authorization computer;
receiving, by the server computer, a transaction response message indicating approval of the transaction from the authorization computer, wherein the transaction response message includes a script for updating a balance amount in the memory unit in the portable device; and
sending, by the server computer, the transaction response message to the access device, wherein the balance amount stored in the memory unit of the portable device is modified using the script.

2. The method of claim 1, wherein the transaction response message is generated upon confirming that the load amount is present in an account identified by the account identifier.

3. The method of claim 1, wherein the transaction request message is an original credit transaction (OCT) message with zero value indication in the transaction amount data field.

4. The method of claim 3, wherein the load amount is indicated in an existing data field of the OCT message, the existing data field being modified to incorporate the load amount.

5. The method of claim 1, wherein the load indicator in the transaction amount data field indicates that the transaction request message does not require clearing and settlement processes.

6. The method of claim 1, wherein the load amount is debited from an account identified by the account identifier and the balance amount stored in the memory unit of the portable device is increased by the load amount.

7. The method of claim 1, wherein the load indicator is a zero value amount.

8. The method of claim 1, wherein the transaction request message is generated by the access device.

9. A server computer comprising:
a processor for executing instructions to:
receive a transaction request message for a transaction after a portable device comprising a data processor and a memory unit interacts with an access device, the transaction request message including a plurality of data fields comprising a transaction amount data field, a supplemental data field, and an account identifier data field, wherein the account identifier data field contains an account identifier associated with the portable device, the supplemental data field contains a load amount, and the transaction amount data field contains a load indicator;
evaluate the transaction request message;
determine an authorization computer associated with the account identifier based on the evaluation;
send the transaction request message to the authorization computer;
receive a transaction response message indicating approval of the transaction from the authorization computer, wherein the transaction response message includes a script for updating a balance amount in the memory unit in the portable device; and
send the transaction response message to the access device, wherein the balance amount stored in a memory unit of the portable device is modified using the script.

10. The server computer of claim 9, wherein the transaction response message is generated upon confirming that the load amount is present in an account identified by the account identifier.

11. The server computer of claim 9, wherein the transaction request message is an original credit transaction (OCT) message with zero value indication in the transaction amount data field.

12. The server computer of claim 11, wherein the load amount is indicated in an existing data field of the OCT message, the existing data field being modified to incorporate the load amount.

13. The server computer of claim 9, wherein the load indicator in the transaction amount data field indicates that the transaction request message does not require clearing and settlement processes.

14. The server computer of claim 9, wherein the load amount is debited from an account identified by the account identifier and the balance amount stored on the portable device is increased by the load amount.

15. The server computer of claim 9, wherein the load indicator is a zero value amount.

16. The server computer of claim 9, wherein the transaction request message is generated by the access device.

17. A method comprising:
interacting, by an access device, with a portable device comprising a data processor and a memory unit;
receiving, by the access device, data associated with the portable device, the data including a load amount and an account identifier associated with the portable device;
generating, by the access device, a transaction request message including a plurality of data fields comprising a transaction amount data field, a supplemental data field, and an account identifier data field, wherein the account identifier data field contains the account identifier associated with the portable device, the supplemental data field contains the load amount, and the transaction amount data field contains a load indicator;
sending, by the access device, the transaction request message to an authorization computer through one or more server computers;
receiving, by the access device, a transaction response message indicating approval of the transaction from the authorization computer, wherein the transaction response message includes a script for updating a balance amount stored in the memory unit of the portable device; and
modifying, by the access device, the balance amount stored on the portable device using the script.

18. The method of claim 17, wherein the transaction request message is an original credit transaction (OCT) message with zero value indication in the transaction amount data field.

19. The method of claim 17, wherein the transaction response message is generated upon confirming that the load amount is present in an account identified by the account identifier.

20. The method of claim 17, wherein the load amount is debited from an account identified by the account identifier and the balance amount stored on the portable device is increased by the load amount.
